(19) United States
(12) Patent Application Publication
(10) Pub. No.: US 2014/0353519 A1
(43) Pub. Date: Dec. 4, 2014

(54) ATTACHED GERMICIDAL LAMP ASSEMBLY

(71) Applicant: ELKO Electronic Products Corp., Taipei 114 (TW)

(72) Inventor: Yu-Chin WANG, Taipei 114 (TW)

(21) Appl. No.: 13/903,978

(22) Filed: May 28, 2013

(51) Int. Cl. A01K 63/04

(52) U.S. Cl. CPC A01K 63/04
USPC 250/435

(57) ABSTRACT

An attached germicidal lamp includes a delivery pipe defining therein an axially extending open hole for delivering a fluid, a compartment formed integral with the periphery of the delivery pipe and defining therein a top-open accommodation chamber, a window provided between the axially extending open hole and the top-open accommodation chamber, and a LED lamp accommodated in the top-open accommodation chamber of the compartment and adapted to emit light through the window toward the axially extending open hole of the delivery pipe to sterilize a fluid passing through the axially extending open hole.

### BACKGROUND OF THE INVENTION

1. Field of the Invention

The present invention relates fluid sterilizing devices and more particularly, to an attached germicidal lamp assembly, which is attachable to a fluid delivery field for sterilizing a liquid or gas.

2. Description of the Related Art

Regular aquariums usually will use a germicidal lamp to sterilize the supplied water, preventing water eutrophication and cleaning the water, so as to provide a better living environment for breeding aquatic animals and plants. Germicidal lamps for this purpose are commonly configured to emit ultraviolet lights for destroying protein, algae and plankton so as to purify the water inside the aquarium.

According to conventional techniques, the germicidal lamp is directly put in the water in the aquarium and controlled to emit ultraviolet light rays into the water in the aquarium for sterilization. However, because the effective range of the ultraviolet light rays emitted by a germicidal lamp for aquarium is limited, the sterilization effect of the ultraviolet light rays emitted by a germicidal lamp in an aquarium is diminished by distance, resulting in a low performance. If a sterilization cycle structure is used, the cost will be very high. Further, the housing of a germicidal lamp for dipping in the water in an aquarium is generally made out of an engineering plastic material that deteriorates quickly under the radiation of ultraviolet light rays. Thus, conventional germicidal lamps for aquarium commonly have a short lifespan. They are quite uneconomical.

### SUMMARY OF THE INVENTION

The present invention has been accomplished under the circumstances in view. It is main object of the present invention to provide an attached germicidal lamp assembly, which provides a wide range of applications.

It is another object of the present invention to provide an attached germicidal lamp assembly, which is made in an economical way and capable of achieving comprehensive purification.

It is still another object of the present invention to provide an attached germicidal lamp assembly, which is effective and durable in use, having a long lifespan.

To achieve these and other objects of the present invention, a germicidal lamp assembly of the present invention comprises a double open-ended delivery pipe defining therein an axially extending open hole for delivering a fluid, a compartment formed integral with the periphery of the double open-ended delivery pipe and defining therein a top-open accommodation chamber, a window provided between the axially extending open hole of the double open-ended delivery pipe and the top-open accommodation chamber of the compartment, and a LED lamp, which comprises a lamp holder mounted in the top-open accommodation chamber of the compartment and a plurality of light-emitting diodes mounted at the lamp holder and adapted to emit light through the window toward the axially extending open hole of the delivery pipe to sterilize a fluid passing through the axially extending open hole.

Preferably, the LED lamp further comprises a light-transmissive airtight shield surrounding the lamp holder and the light-emitting diodes.

Further, the light-emitting diodes are mounted at the lamp holder by surface mount technology.

Preferably, the germicidal lamp assembly further comprises an adapter pipe having a cap-like connection portion located at a bottom end thereof and fastened to a top open end of the double open-ended delivery pipe and the corresponding end of the compartment.

Further, the double open-ended delivery pipe has a bottom open end thereof connected to a water pump. Further, the adapter pipe is connected to a filter through a connection pipe.

Further, the fluid passing through the double open-ended delivery pipe can be a fluid or gas.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an exploded view of an attached germicidal lamp assembly in accordance with the present invention.

FIG. 2 is a sectional elevation of the attached germicidal lamp assembly in accordance with the present invention.

FIG. 3 is a schematic sectional assembly view of the attached germicidal lamp assembly in accordance with the present invention.

FIG. 4 is a schematic drawing of the present invention, illustrating the attached germicidal lamp assembly used in an aquarium.

FIG. 5 is a schematic sectional view of the present invention illustrating a fluid sterilization operation of the attached germicidal lamp assembly.

FIG. 6 is a schematic sectional view of the present invention illustrating a gas sterilization operation of the attached germicidal lamp assembly.

### DETAILED DESCRIPTION OF THE PREFERRED EMBODIMENT

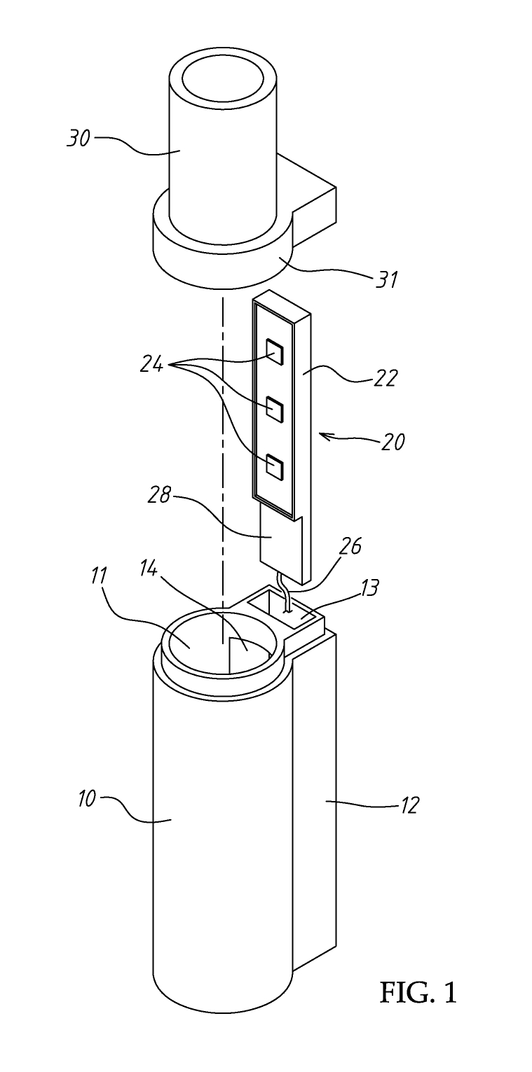

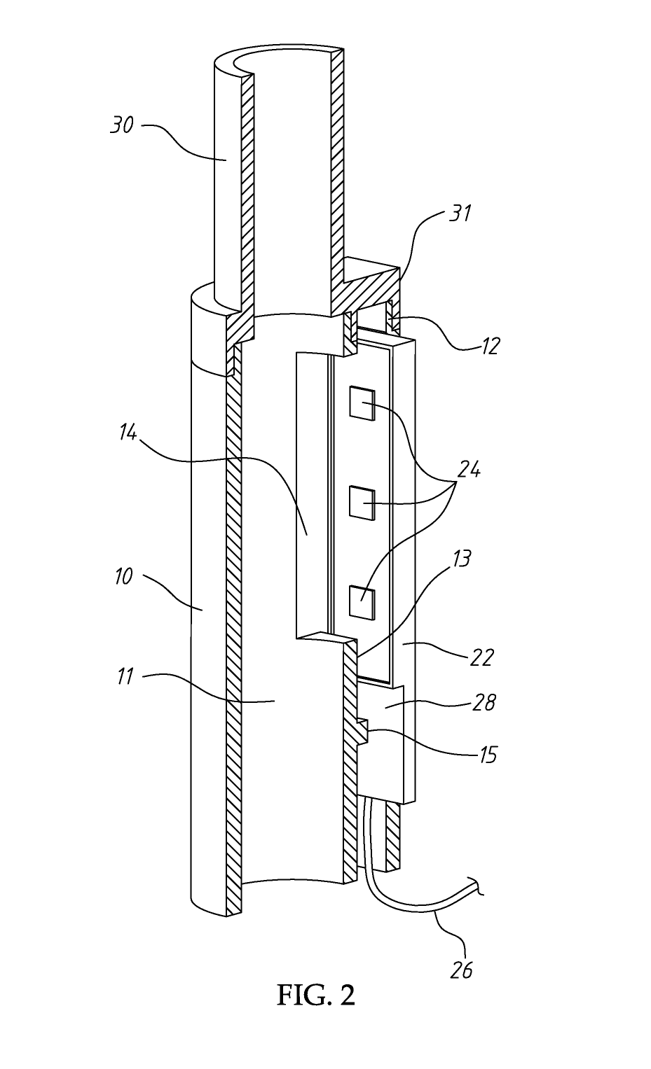

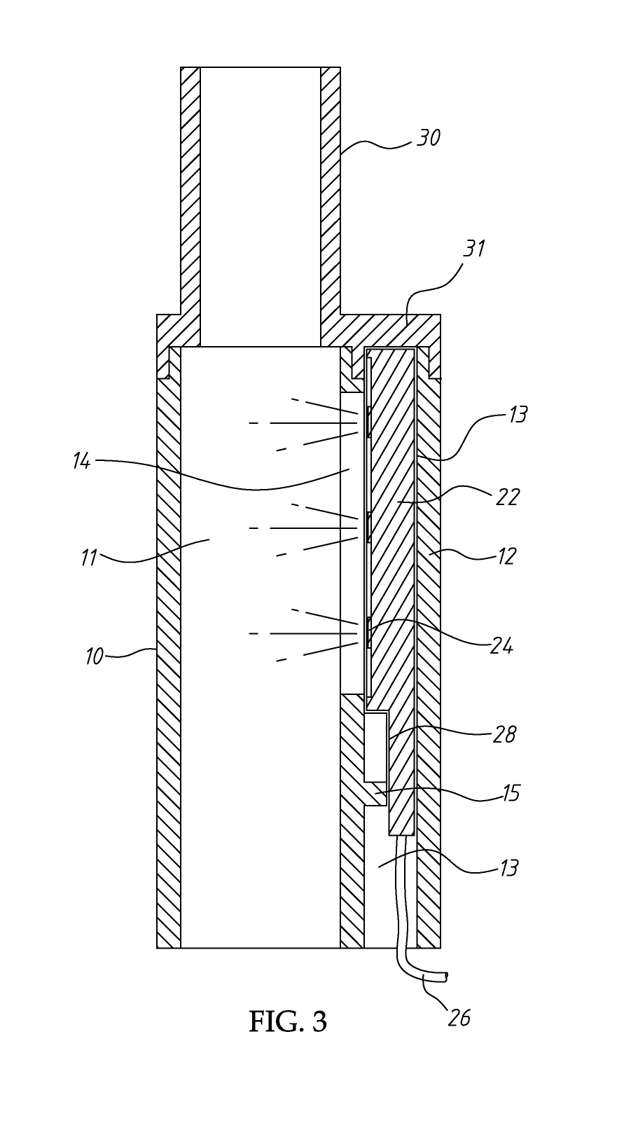

Referring to FIGS. 1-3, a double open-ended delivery pipe 10 defining therein an axially extending open hole 11 for delivering a fluid (liquid or gas) is shown. A compartment 12 is formed integral with the periphery of the double open-ended delivery pipe 10, defining a top-open accommodation chamber 13. A window 14 is provided between the axially extending open hole 11 of the double open-ended delivery pipe 10 and the top-open accommodation chamber 13 of the compartment 12. A LED lamp 20 is mounted in the top-open accommodation chamber 13 of the compartment 12.

The LED lamp 20 comprises a lamp holder 22 fitting the configuration of the top-open accommodation chamber 13 of the compartment 12, a plurality of SMDs (surface mounted devices), for example, ultraviolet LEDs (light-emitting diodes) 24 mounted at the lamp holder 22 by surface mount technology and adapted to emit light through the window 14 toward the flow of gas or air passing through the axially extending open hole 11, and a power cord 26 electrically coupled with the ultraviolet LEDs (light-emitting diodes) 24 and extended out of the lamp holder 22 for connection to an external power source.

The lamp holder 22 has a recessed portion 28 at the bottom side thereof. The compartment 12 comprises an inside stop flange 15 suspending in the top-open accommodation chamber 13 laterally near the bottom side and fitting the recessed portion 28 of the lamp holder 22 for holding the LED lamp 20 steadily in the top-open accommodation chamber 13. Further, necessary leak-proof measures can be taken to prevent leakage. Further, an adapter pipe 30 is provided having a cap-like connection portion 31 located at a bottom end thereof and fastened to the top open end of the double open-ended delivery pipe 10 and the corresponding end of the compartment 12.

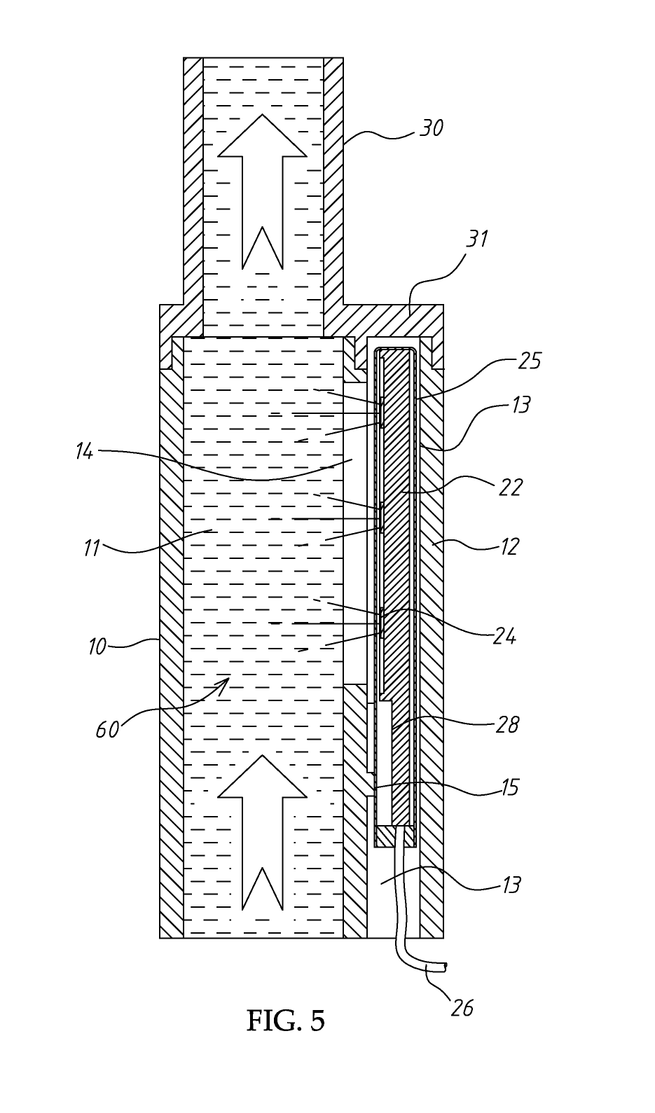

Further, as shown in FIG. 5, the LED lamp 20 can be protected in a light-transmissive watertight shield, for example, watertight quartz glass shield 25 before mounting in the compartment 12.

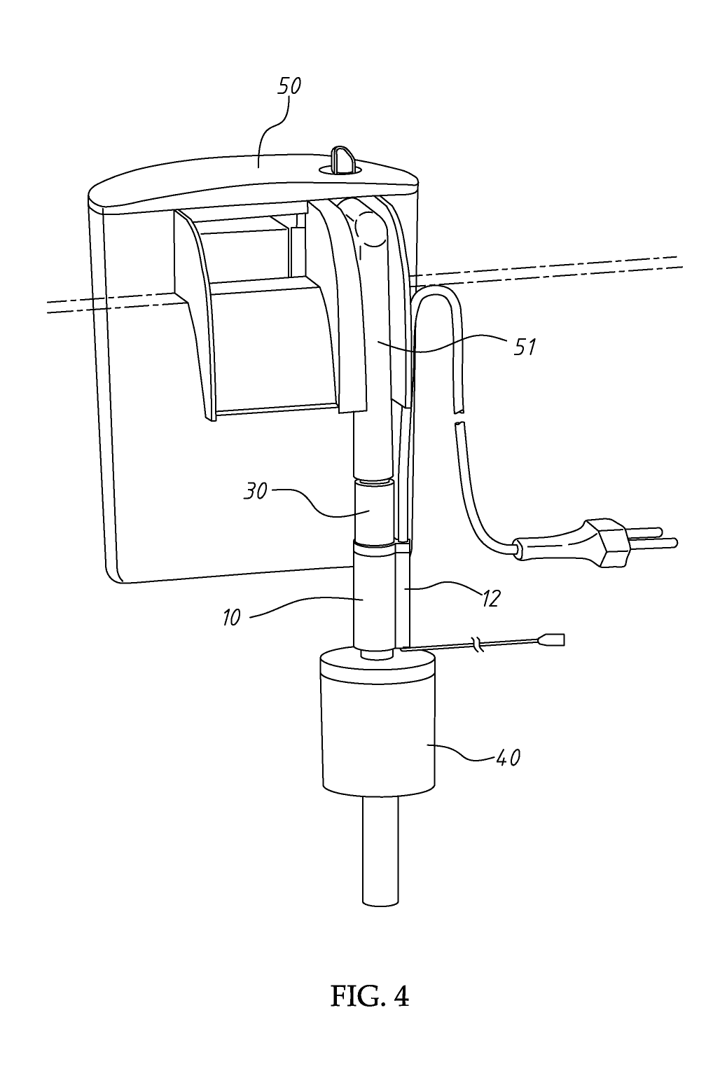

Referring to FIG. 4, for use in an aquarium, a water pump 40 can be attached to the bottom open end of the double open-ended delivery pipe 10, and the adapter pipe 30 can be connected to a filter 50 through a connection pipe 51.

Referring to FIG. 5, when the attached germicidal lamp assembly 10 is used for fluid sterilization, the fluid 60 is driven by a power device (for example, the water pump 40 shown in FIG. 4) into the axially extending open hole 11 of the delivery pipe 10. When the pumped fluid 60 passes by the window 14 toward another apparatus (for example, the filter 50 shown in FIG. 4), it is sterilized by the ultraviolet light rays emitted by the ultraviolet LEDs (light-emitting diodes) 24.

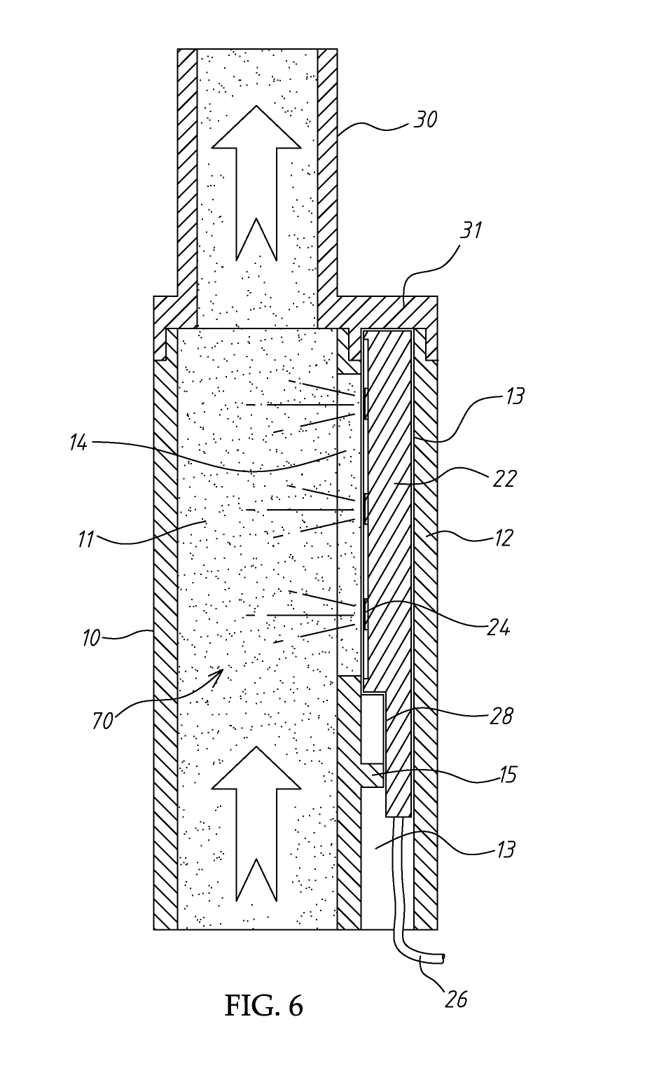

Referring to FIG. 6, the attached germicidal lamp assembly 10 can also be used for sterilizing a gas 70. In this application example, it is not necessary to the ultraviolet LED lamp 20 with a light-transmissive airtight shield.

For use in an aquarium or other fluid purification field, the invention adopts a proximity way to perform an ultraviolet irradiation purification operation, effectively and economically achieving fluid purification. Further, the ultraviolet LED lamp 20 of the invention has the advantages of long lifespan, and effectively eliminates the quick deterioration problem of conventional designs due to long-term exposure. Further, the invention is applicable to different fluid and gas purification fields, supporting a wide range of applications.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A germicidal lamp assembly, comprising:
a double open-ended delivery pipe defining therein an axially extending open hole for delivering a fluid;
a compartment formed integral with the periphery of said double open-ended delivery pipe, said compartment defining a top-open accommodation chamber;
a window provided between said axially extending open hole of said double open-ended delivery pipe and said top-open accommodation chamber of said compartment; and
a LED lamp comprising a lamp holder configured subject to the configuration of said top-open accommodation chamber of said compartment and mounted in said top-open accommodation chamber of said compartment, and a plurality of light-emitting diodes mounted at said lamp holder and adapted to emit light through said window toward said axially extending open hole of said delivery pipe to sterilize a fluid passing through said axially extending open hole.

2. The germicidal lamp assembly as claimed in claim 1, wherein said light-emitting diodes are mounted at said lamp holder by surface mount technology.

3. The germicidal lamp assembly as claimed in claim 1, wherein said LED lamp further comprises a light-transmissive airtight shield surrounding said lamp holder and said light-emitting diodes.

4. The germicidal lamp assembly as claimed in claim 3, wherein said light-transmissive airtight shield is a quartz glass shield.

5. The germicidal lamp assembly as claimed in claim 1, further comprising an adapter pipe having a cap-like connection portion located at a bottom end thereof and fastened to a top open end of said double open-ended delivery pipe and the corresponding end of said compartment.

6. The germicidal lamp assembly as claimed in claim 5, wherein said double open-ended delivery pipe has a bottom open end thereof connected to a water pump; said adapter pipe is connected to a filter through a connection pipe.

7. The germicidal lamp assembly as claimed in claim 1, wherein said fluid is one of fluid and gas.

8. The germicidal lamp assembly as claimed in claim 3, wherein said fluid is one of fluid and gas.

9. The germicidal lamp assembly as claimed in claim 5, wherein said fluid is one of fluid and gas.
